(19) United States
(12) Patent Application Publication
(10) Pub. No.: US 2001/0049081 A1
(43) Pub. Date: Dec. 6, 2001

(54) Orthodontic separator loop

(76) Inventor: Nelson Krupp, Abington, PA (US)

Correspondence Address: Connolly Bove Lodge & Hutz LLP, P.O. Box 2207, Wilmington, DE, 19899-2207, US

(21) Appl. No.: 09/859,081

(22) Filed: May 16, 2001

Related U.S. Application Data
(60) Provisional application No. 60/208,577, filed on Jun. 2, 2000.

(51) Int. Cl. A61C 3/00

(52) U.S. Cl. 433/18; 433/24

(57) ABSTRACT

An orthodontic separator loop is in the form of an elastomeric ring module having at least one protrusion extending outwardly from the ring body. In the preferred practice of the invention two such protrusions are provided. The protrusions preferably extend radially from the center of the ring body 180° apart from each other.

### CROSS-REFERENCE TO RELATED APPLICATION

This application is based on provisional application Serial No. 60/208,577, filed Jun. 2, 2000.

### BACKGROUND OF THE INVENTION

Orthodontic practitioners have the need of moving teeth away from each other in order to place metal “bands” around molar teeth. These bands provide an anchorage base for the archwire and other orthodontic appliances used in the patient's mouth. Prior art techniques use either metal springs or elastomeric ring modules, these being applied at each space requiring widening. Problems with the prior art techniques are possible injury to the patient from dislodged and ingested metal separator.

The elastomeric ring separator removed the danger of ingestion but introduced a new problem. These rings, torus-shaped, are applied to their purpose by being stretched with a plier and placed between the teeth to the gum line. This process is akin to the path of a strand of dental floss used in the mouth. When placed against the gingiva, the plier is removed and the device is allowed to recover its original shape and thickness. The forces applied to the teeth during this equilibration are so as to provide more space between teeth to allow placement of metal “bands”. This process takes place over several days time. Occasionally these loops are gone when patients return to the practitioner. In these cases the practitioner must be assured that the loop has not been drawn in between the teeth. The reasons being that these plastics are not those intended for long-term in vivio applications and that the physical presence of such a foreign object can adversely affect orthodontic treatment and patient comfort. This problem has been addressed by the introduction of radio-opaque salts compounded into the material of the loop. Upon discovering a missing ring, the practitioner would use X-ray radiography to produce an image of the suspect area in the mouth, then use surgical means to retrieve the submerged ring.

### SUMMARY OF THE INVENTION

An object of this invention is to provide an orthodontic separator loop which overcomes the above disadvantages.

A further object of this invention is to provide such an orthodontic separator loop which is easy to apply, effective in use and avoids being drawn into the space between the teeth and below the gumline.

In accordance with this invention the orthodontic separator loop is an elastomeric ring provided with at least one outwardly extending protrusion extending away from the outer periphery of the ring. Preferably two protrusions are provided which are disposed 180° apart. The protrusions merge with the ring module with minimal sharp external corners.

### THE DRAWINGS

FIG. 1 is a top plan view of an orthodontic separator loop in accordance with one embodiment of this invention;

FIGS. 2-3 are front and end elevational views of the loop shown in FIG. 1;

FIG. 4 is a top plan view of a modified form of loop in accordance with a further embodiment of this invention;

FIG. 5 is a schematic side elevational view showing the loop of this invention in place between two molar teeth; and

FIG. 6 is a top plan view of a dispensing arrangement for a plurality of the loops shown in FIGS. 1-3.

### DETAILED DESCRIPTION

The present invention is based upon providing an orthodontic separator loop which comprises a modification of the conventional elastomeric ring modules. Such loops are used to create extra space between crowded teeth for placement of metal bands which totally encircle the tooth, these primarily being molar teeth. The elastic loop is stretched using a plier having jaws inserted into the loop. The loop is stretched or widens as force is applied with the hand. This distended loop is then squeezed down between the teeth with the plier, one jaw being on the lingual (inside) the other being on the labial (cheek) side of the toothline (much as one uses dental floss). Upon its touching the gumline it is released from the plier. The elastic property of the ring then causes the ring, having been stretched to as much as 5 times its original diameter, to recover its original smaller shape. In doing this the diameter of the cross section of the ring tends to increase to its original molded shape. This action, over time (some days in fact), causes the teeth to move apart, this being the intended reaction.

Conventionally, rings of this type are molded predominately in a blue color to contrast with the patient's mouth and assist in locating and removal upon the patient's next visit. This often is not enough, however, with prior art loops. These loops are rather small in diameter facilitating the required tooth movement. Occasionally this causes the loop to be drawn into the space between the teeth and down below the gumline. Such products are certified by FDA to be in the mouth less than 29 days. Some chemicals can be released by the material after this. This fact and the fact that any surgical device not intended to remain in the patient makes this sub-gingival loss an occurrence to be avoided. One form of prior art loop is doped with a radio-opaquing agent. This causes the otherwise invisible loop to appear on an X-ray radiograph allowing the practitioner to rule out sub-gingival loss as an explanation for a missing ring.

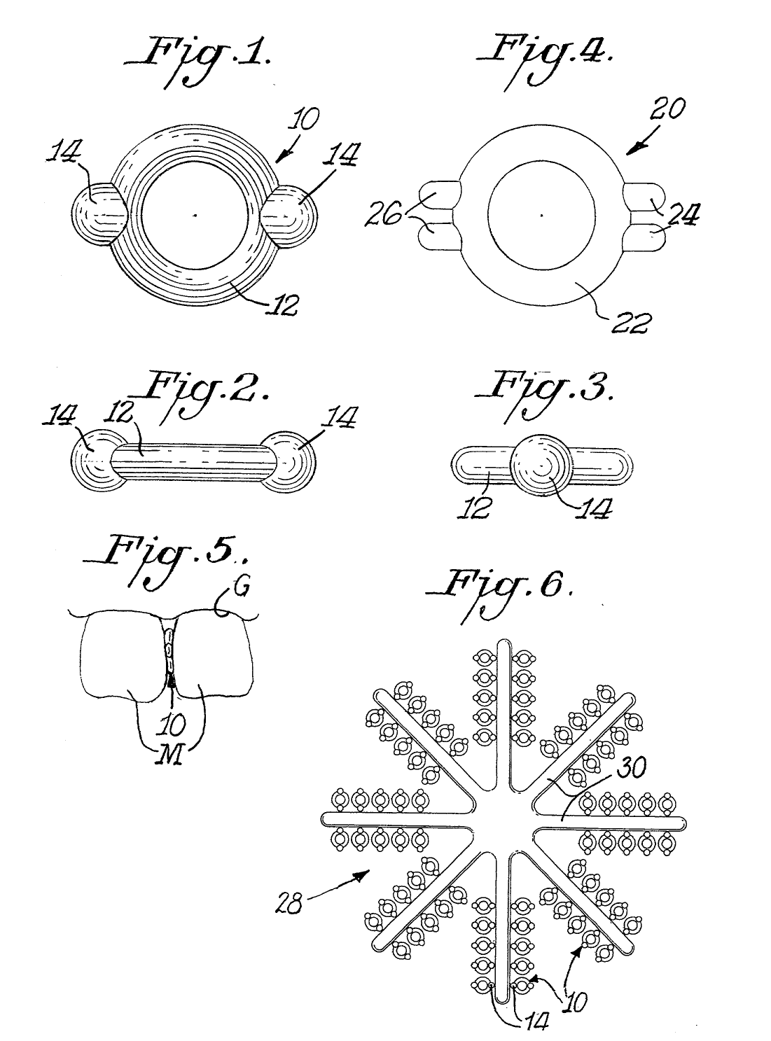

The present invention overcomes the need to dope the loop with a radio-opaquing agent. This is accomplished by providing a mechanical means for avoiding sub-gingival loss of the device. FIGS. 1-3 illustrate a preferred practice of the invention. As shown therein the orthodontic separator loop 10 is generally formed of an elastomeric ring module body 12 as with conventional elastomeric loops. Loop 10, however, includes round protrusions 14,14 preferably made of solid material molded on ring module body 12 preferably located 180° apart. Protrusions 14,14 preferably extend radially with respect to the center of ring module body 12. Having protrusions 14,14 results in providing the practitioner with a separator module ring having physical means of preventing its loss without use of heavy elements as radio-opaque agents or the need of extra radiation exposure for the patient. These protuberances or protrusions 14,14 would also serve to strengthen the ring module by providing a much larger weld-line surface area. An additional benefit is in the easier removal of the separator loop after the prescribed application time due to the presence of the larger protuberance 14,14. For the benefit of the patient the protrusions merge into the ring body with no or with minimal sharp external corners.

As indicated above, FIGS. 1-3 illustrate the preferred practice of the invention where two such protrusions 14,14 are provided located 180° apart. The invention, however, may be practiced with other shapes or numbers of protrusions. For example, FIG. 4 illustrates a modified loop 20 having a ring module body 22 with a pair of protrusions 24,24 extending from one portion of the ring body 22 and a second pair of protrusions 26,26 in line with the first pair. Other variations include having protrusions on only one portion of the loop or having a different number of protrusions on opposite portions such as one protrusion at one side about 180° apart from two or more protrusions on the other side or having only a single protrusion for the entire loop. The protrusions on one side could be of a different size and/or shape than the protrusions on the opposite side of the ring body.

Preferably, as shown in FIG. 2 the protrusions and the ring body have the same general curvature. The protrusions and ring body may have the same thickness. Preferably, however, the protrusions are thicker than the ring body as shown in FIGS. 2-3. In this respect, the protrusions extend beyond the teeth while the ring body is located between adjacent teeth. Thus, it is more critical to minimize the thickness of the ring body without sacrifice to its strength whereas the protrusion could have a greater thickness than the ring body and not interfere with the operation of the loop.

The elastomeric separator 10 may be made of any suitable material, such as thermoplastic polyurethane. Other elastomeric materials can be used, including multi-layered or coated elastomerics (such as latex rubber or polyurethane with friction-reducing coatings). Ring body 12 generally has a diameter of from 0.160 to 0.200 inches, and preferably 0.180 inches. The circular central opening of ring body 12 is preferably 0.100 inches. Ring body 12 generally has a maximum thickness of from 0.030 to 0.080 inches, and preferably 0.040 or 0.050 inches. Protrusion 14 preferably has a thickness of 0.063 inches and generally extends outwardly from ring body 12 from 0.030 to 0.080 inches, and preferably 0.050 inches. The overall length of loop 10 from one end of one protrusion 14 to the diametrically opposite end of the other protrusion is preferably 0.243 or 0.255 inches

FIG. 5 illustrates the separator loop 10 mounted in place between two molars M,M outwardly of the gumline G.

Although FIGS. 1-3 illustrate the protrusions 14,14 to be mirror images of each other, each protrusion may have a shape or be dimensioned to be different than the other protrusions, such as being longer, wider, thicker, etc.

In addition to the protrusions functioning to strengthen the ring module the protrusions also may function as readily accessible tabs to facilitate the removal of the separator loops as indicated above.

FIG. 6 illustrates a dispenser 28 for dispensing a plurality of loops 10. As shown therein the dispenser has a plurality of spokes 30 radiating from its central area. A plurality of loops 10 are integrally molded to the spokes 30. When it is desired to use a loop 10, the loop is simply detached from its spoke 30 at the patient's chair side. Thus, the practitioner has a plurality of loops readily available and readily accessible despite the relatively small size of the individual loops while minimizing the possibility of misplacing any loop.

In the preferred practice of the invention as shown in FIG. 1 the protrusions 14,14 extend radially from the center of the ring module 12. FIG. 3, however, illustrates the variation where the protrusions are transverse to the ring shaped body 12, but off-center. If desired, the protrusions may also be located so as to be tangent to the ring body.

It is to be understood that the invention can also be practiced by forming the loop by extruding a tubing of elastomeric material with “bumps” on one or more sides. The tubing would then be cut to produce the finished loop with the “bumps” comprising the protrusions.

What is claimed is:

1. An orthodontic separator loop comprising a ring module made of an elastomeric material capable of being stretched from its original unstretched position and then tending to return to its unstretched position, and at least one outwardly extending protrusion extending outwardly from said ring module.

2. The loop of claim 1 including a plurality of said protrusions.

3. The loop of claim 2 wherein said plurality of said protrusions comprise at least one protrusion mounted about 180° from at least another one of said protrusions.

4. The loop of claim 3 wherein said protrusions extend radially from the center of said ring module.

5. The loop of claim 2 wherein said plurality of protrusions merge with said ring module with minimal sharp external corners.

6. The loop of claim 2 wherein there are more than two of said protrusions.

7. The loop of claim 2 wherein said ring module is generally circular in shape having a diameter of 0.160 to 0.200 inches and a thickness of 0.030 to 0.080 inches, and each of said protrusions extending outwardly from said ring module from 0.030 to 0.080 inches.

8. The loop of claim 7 wherein said loop has an overall length of from 0.243 to 0.255 inches.

9. The loop of claim 1 wherein said at least one protrusion is thicker than said ring module.

10. The loop of claim 1 wherein said at least one protrusion is of the same thickness as said ring module.

11. The loop of claim 1 wherein said loop is made of an elastomeric material free of a radio-opaquing agent.

12. The loop of claim 1, in combination therewith, a plurality of said loops, a dispenser having a plurality of spokes radiating from a central area, and said loops detachably integrally connected to said spokes.

13. In a method of moving teeth away from each other by use of an elastomeric separator loop being inserted between adjacent teeth, the improvement being in using as the elastomeric loop the separator loop of claim 1.
